(19) United States
(12) Patent Application Publication
(10) Pub. No.: US 2016/0335966 A1
(43) Pub. Date: Nov. 17, 2016

(54) LIQUID CRYSTAL DISPLAY DEVICE

(71) Applicant: Panasonic Liquid Crystal Display Co., Ltd., Himeji-shi (JP)

(72) Inventor: Toshiyuki KUMAGAI, Kanagawa (JP)

(21) Appl. No.: 15/223,696

(22) Filed: Jul. 29, 2016

Related U.S. Application Data
(63) Continuation of application No. PCT/JP2014/000490, filed on Jan. 30, 2014.

(51) Int. Cl. G09G 3/36

(52) U.S. Cl. CPC G09G 3/3614; G09G 3/3677; G09G 3/3688; G09G 2310/06; G09G 2310/08; G09G 2330/021

(57) ABSTRACT

A liquid crystal display device comprising: a plurality of data lines; a plurality of scanning lines; a plurality of source drivers that supply a data signal to the plurality of data lines; a gate driver that supplies a scanning signal to the plurality of scanning lines; and a display control circuit that controls the plurality of source drivers and the gate driver. The display control circuit includes an image determinator that determines whether an externally-input image includes a pattern image and a polarity signal generator that generates a polarity signal deciding a voltage polarity of the data signal in each source driver based on a determination result of the data signal. The polarity signal generator individually outputs each of the plurality of generated polarity signals to the corresponding source driver.

### CROSS-REFERENCE TO RELATED APPLICATION

This application is bypass continuation of international patent application PCT/JP2014/000490, filed: Jan. 30, 2014 designating the United States of America, the entire disclosure of which is incorporated herein by reference.

### TECHNICAL FIELD

The present invention relates to a liquid crystal display device.

### BACKGROUND

In the liquid crystal display device, an electric field generated between a pixel electrode formed in each pixel region and a common electrode is applied to liquid crystal to drive the liquid crystal, whereby a quantity of light transmitted through a region between the pixel electrode and the common electrode is adjusted to display an image. A thin film transistor is formed near an intersection portion of a gate line and a source line in each pixel region.

Conventionally, in the liquid crystal display device, there is known a problem in that, in writing a data signal (gradation voltage) in a pixel, a common voltage varies due to a content of an input image to deteriorate display quality. For example, A prior art discloses a technology for solving the problem (See Japanese unexamined published patent application No.

In the liquid crystal display device in the prior art, when a specific pattern image is detected, a reverse correction voltage is generated in order to cancel the common voltage variation, and a common voltage in which the generated reverse correction voltage is superposed on a reference common voltage is supplied to the common electrode.

### SUMMARY

However, in the liquid crystal display device in the prior art, it is necessary that the variation in common voltage be previously calculated to generate the reverse correction voltage canceling out the common voltage variation, which leads to a complicated configuration of the liquid crystal display device.

An object of the present disclosure is to provide a liquid crystal display device in which the display quality deterioration associated with the common voltage variation can be suppressed with a simple configuration.

To solve the above problem, a liquid crystal display device according to the present disclosure comprises: a plurality of data lines;

a plurality of scanning lines;

a plurality of source drivers that supply a data signal to the plurality of data lines;

a gate driver that supplies a scanning signal to the plurality of scanning lines; and

a display control circuit that controls the plurality of source drivers and the gate driver,

wherein the display control circuit includes an image determinator that determines whether an externally-input image includes a pattern image and a polarity signal generator that generates a polarity signal deciding a voltage polarity of the data signal in each source driver based on a determination result of the data signal, and

the polarity signal generator individually outputs each of the plurality of generated polarity signals to the corresponding source driver.

In the liquid crystal display device according to the present disclosure, the pattern image may be an image in a region where a pixel group having a brightness difference between adjacent pixels that is greater than or equal to a predetermined value is continued over an area greater than or equal to a predetermined area.

In the liquid crystal display device according to the present disclosure, each of the source drivers may be connected to a respective driving region and the image determinator may determine which one of the driving regions includes the pattern image, and

based on the determination result of the image determinator, the polarity signal generator outputs a first polarity signal to the source driver that drives the driving region including the pattern image, and outputs a second polarity signal to the source driver that drives the driving region that does not include a pattern image.

In the liquid crystal display device according to the present disclosure, the pattern image may be a checkered pattern image in which black and white are alternately changed in each pixel,

the first polarity signal is a signal in which a high level and a low level are switched in each frame, and

the second polarity signal is a signal in which a high level and a low level are switched in each horizontal scanning period in a period during which the pattern image is displayed, and is an in-phase signal of the first polarity signal in a period during which the pattern image is not displayed.

In the liquid crystal display device according to the present disclosure, the source driver to which the first polarity signal may be input performs column inversion drive, and

the source driver to which the second polarity signal may be input performs the column inversion drive in the period during which the pattern image is not displayed, and performs dot inversion drive in the period during which the pattern image is displayed.

In the liquid crystal display device according to the present disclosure, the pattern image may be a checkered pattern image in which black and white are alternately changed in each pixel,

the first polarity signal may be a signal in which a high level and a low level are switched in each frame, and

the second polarity signal may be an anti-phase signal of the first polarity signal in a period during which the pattern image is displayed, and is a signal having an in-phase phase of the first polarity signal in a period during which the pattern image is not displayed.

In the liquid crystal display device according to the present disclosure, each of the plurality of source drivers may perform the column inversion drive, and the pixel in the driving region of the source driver to which the second polarity signal may be input and the pixel in the driving region of the source driver to which the first polarity signal is input differ from each other in the voltage polarity.

The liquid crystal display device according to the present disclosure comprises: a plurality of data lines;

a plurality of scanning lines;

a plurality of source drivers that supply a data signal to the plurality of data lines, each of the plurality of source drivers includes a switch that switches between a one-column inversion drive and a two-column inversion drive;

a gate driver that supplies a scanning signal to the plurality of scanning lines; and

a display control circuit that controls the plurality of source drivers and the gate driver,

wherein the display control circuit includes:
an image determinator that determines whether an externally-input image includes a pattern image, and
a control signal generator that generates a control signal switching between the one-column inversion drive and the two-column inversion drive in each source driver based on a determination result of the image determinator, and

the control signal generator outputs each of the plurality of generated control signals to the switch of the corresponding source driver.

Accordingly, in the liquid crystal display device of the present disclosure, a voltage polarity of the data signal supplied to each source driver can be set according to the content of the input image. Therefore, the display quality deterioration associated with the common voltage variation can be suppressed with the simple configuration.

### BRIEF DESCRIPTION OF DRAWINGS

FIG. 1 is a view illustrating a schematic configuration of a liquid crystal display device according to an exemplary embodiment of the present disclosure;

FIG. 2 is a view illustrating an example of a frame image including a pattern image;

FIG. 3 is a view illustrating an example of a method for driving a general liquid crystal display device;

FIG. 4 is a schematic diagram illustrating a display state of a pixel;

FIG. 5 is a waveform chart illustrating a data signal output to a source line;

FIG. 6 is a block diagram illustrating a schematic configuration of a TCON;

FIG. 7 is a timing chart illustrating a waveform of a polarity signal;

FIG. 8 is a view illustrating a method for driving the liquid crystal display device of the exemplary embodiment;

FIG. 9 is a schematic diagram illustrating the display state of the pixel of the embodiment;

FIGS. 10A and 10B are waveform charts illustrating the data signal output to the source line of the exemplary embodiment;

FIG. 11 is a view illustrating an example of the frame image including the pattern image;

FIG. 12 is a timing chart illustrating the waveform of the polarity signal;

FIG. 13 is a view illustrating a method for driving a liquid crystal display device according to a first modification;

FIG. 14 is a schematic diagram illustrating the display state of the pixel of the first modification;

FIGS. 15A and 15B are waveform charts illustrating the data signal output to the source line of the first modification;

FIG. 16 is a view illustrating a schematic configuration of a liquid crystal display device according to a second modification;

FIG. 17 is a block diagram illustrating a schematic configuration of the TCON of the second modification;

FIG. 18 is a timing chart illustrating the waveforms of the polarity signal and a control signal;

FIG. 19 is a schematic diagram illustrating the display state of the pixel of the second modification; and

FIGS. 20A and 20B are waveform charts illustrating the data signal output to the source line of the second modification.

### DETAILED DESCRIPTION

Hereinafter, an exemplary embodiment of the present disclosure will be described with reference to the drawings.

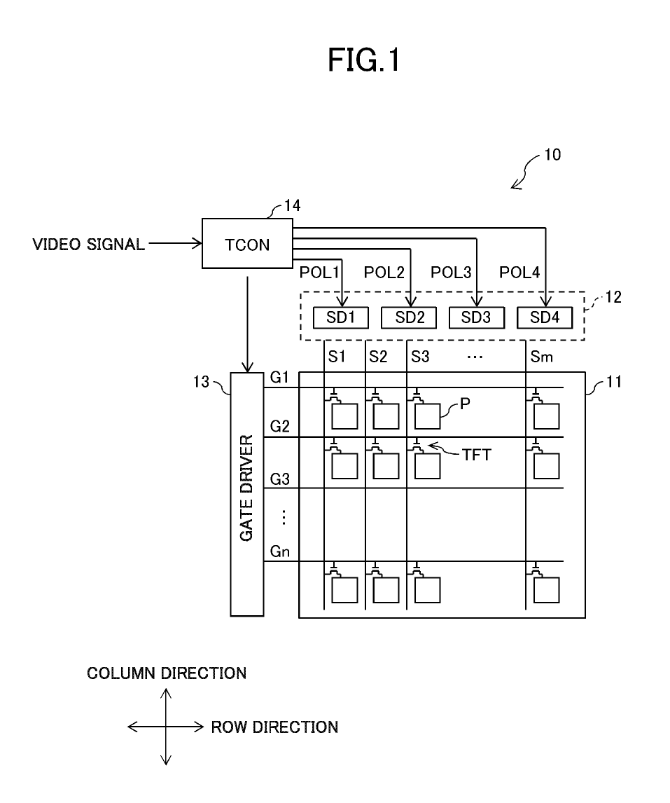

FIG. 1 is a view illustrating an entire configuration of a liquid crystal display device according to an exemplary embodiment. Liquid crystal display device 10 includes liquid crystal panel 11, source driver 12, gate driver 13, and timing controller 14 (TCON) (display control circuit).

Although not illustrated, liquid crystal panel 11 includes a TFT substrate (active matrix substrate), a counter substrate, and a liquid crystal layer sandwiched between both the substrates. A plurality of source lines S1, S2, S3, . . . , Sm (data line) connected to source driver 12 and a plurality of gate lines G1, G2, G3, . . . , Gn (scanning line) connected to gate driver 13 are provided in the TFT substrate, and thin film transistor TFT is provided at each intersecting portion of source line SL and gate line GL. In liquid crystal panel 11, a plurality of pixels P are arranged into a matrix shape (a row direction and a column direction) according to the intersection portions. Liquid crystal panel 11 includes a pixel electrode provided in the TFT substrate corresponding to each pixel P and a common electrode (counter electrode) provided in the counter substrate. The common electrode may be provided in the TFT substrate. Liquid crystal panel 11 displays the image according to a data signal (gradation voltage) supplied to source line SL by switching (ON and OFF) of thin film transistor TFT using a gate signal (scanning signal) supplied to gate line GL.

For example, gate driver 13 sequentially supplies the gate signal to the plurality of gate lines GL from the top of liquid crystal panel 11. Gate driver 13 is provided on one side (the left side in FIG. 1) of liquid crystal panel 11. A known configuration can be applied to gate driver 13.

Source driver 12 supplies the data signal to each of the plurality of source lines SL. Specifically, each source driver SD generates a data signal (gradation voltage) corresponding to gradation (input gradation) of the display data on the basis of a timing signal and display data, which are input from TCON 14, and supplies the generated data signal to each of the plurality of corresponding source lines SL. The display data supplied to source line SL is supplied to the pixel electrode through thin film transistor TFT connected to gate line GL to which the gate signal is supplied. Therefore, the image having brightness corresponding to the gradation of the data signal is displayed on corresponding pixel P.

Source driver 12 is constructed with the plurality of source drivers SD, and the plurality of source drivers SD are arranged on one side (the top side in FIG. 1) of liquid crystal panel 11. Each source driver SD is connected to a corresponding plurality of source lines SL in all source lines SL, and each source driver SD supplies the data signal to the plurality of corresponding source lines SL. That is, the plurality of source drivers SD drive liquid crystal panel 11 in a distributed manner. By way of example, FIG. 1 illustrates a configuration in which four source drivers 12 (SD1, SD2, SD3, and SD4) are arranged in a crosswise direction (row direction). Each of the source drivers 12 (SD1, SD2, SD3, and SD4) is connected to a respective driving region.

Polarity signal POL output from TCON 14 is individually input to each source driver SD. Specifically, for example, in the configuration in FIG. 1, polarity signal POL1 is input to source driver SD1, polarity signal POL2 is input to source driver SD2, polarity signal POL3 is input to source driver SD3, and polarity signal POL4 is input to source driver SD4. The polarity signals POL are independently input to source drivers SD. On the basis of input polarity signal POL, each source driver 12 decides (adds) polarity of the data signal supplied to source line SL. A known configuration can be applied to source driver 12.

On the basis of a video signal (input image), a timing signal (a clock signal, a vertical synchronizing signal, and a horizontal synchronizing signal), and the like, which are supplied from a display system (signal source) such as an external personal computer, TCON 14 generates the display data for image display, polarity signal POL deciding the polarity of the data signal supplied to source line SL, and various timing signals controlling source driver 12 and gate driver 13.

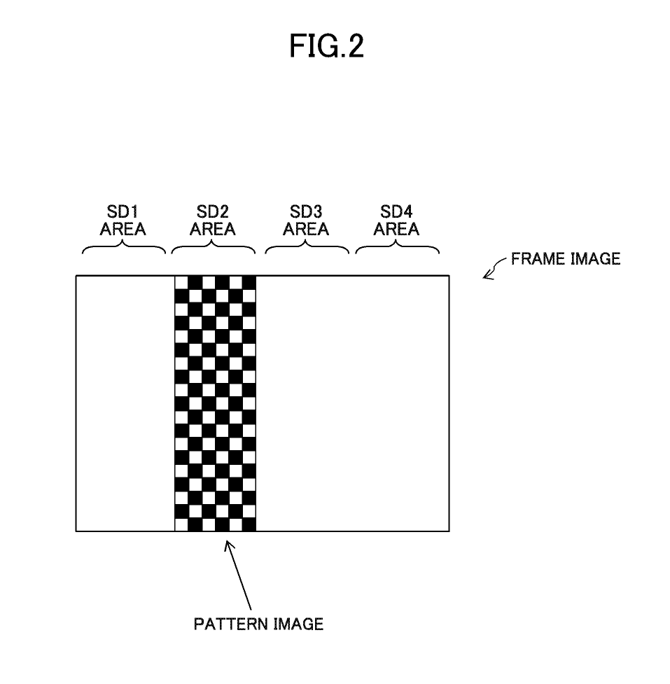

Liquid crystal display device 10 has the configuration in which, in the case that the input video signal (frame image) includes a specific pattern image (killer pattern) providing the variation in potential (common voltage) of the common electrode, an optimum inversion driving system is set in each driving region corresponding to source drivers SD to cancel out the common voltage variation, thereby suppressing the display quality deterioration. As used herein, the pattern image means an image in a region where a pixel group, which has a brightness difference (gradation difference) between pixels adjacent to each other, is continued over an area greater than or equal to a predetermined area in the frame image. For example, as illustrated in FIG. 2, the pattern image is an image in which a quarter of a whole area of the frame image is filled with a black-and-white checkered pattern (a pattern in which black and white are alternately changed in each 1-by-1 dot).

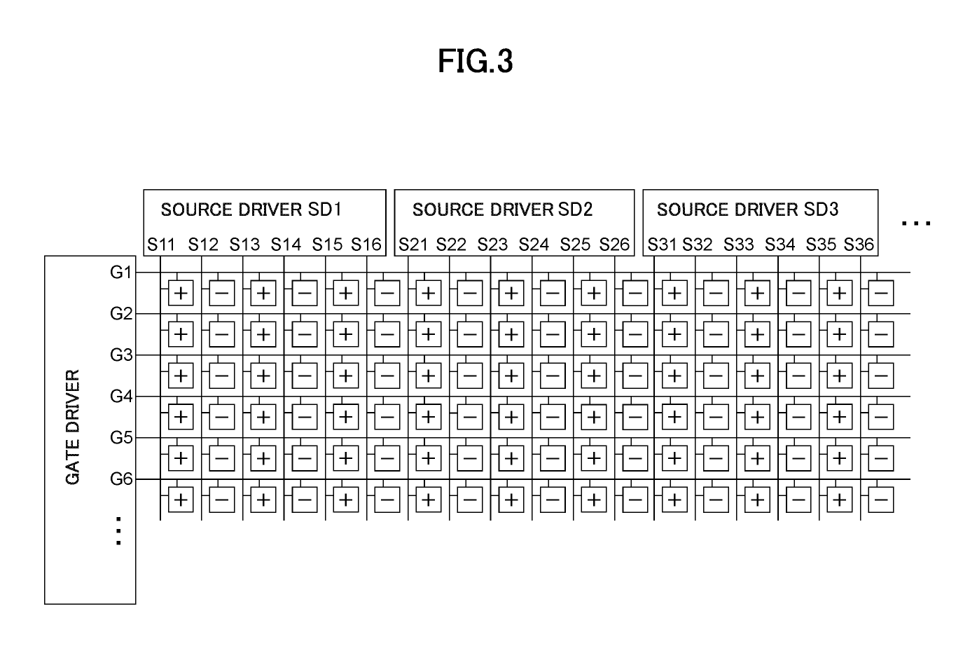

A principle of the common voltage variation caused by the pattern image will be described below. At this point, the frame image in which the pattern image is included in the driving region of source driver SD2 as illustrated in FIG. 2 can be cited as an example. FIG. 3 illustrates an example of a method for driving a general liquid crystal display device. A column line inversion drive (column inversion drive) is illustrated in FIG. 3. In the column inversion drive, the data signals supplied to the adjacent source lines SL differ from each other in the voltage polarity while the common voltage (Vcom) is fixed, and the voltage polarity is inverted in each frame.

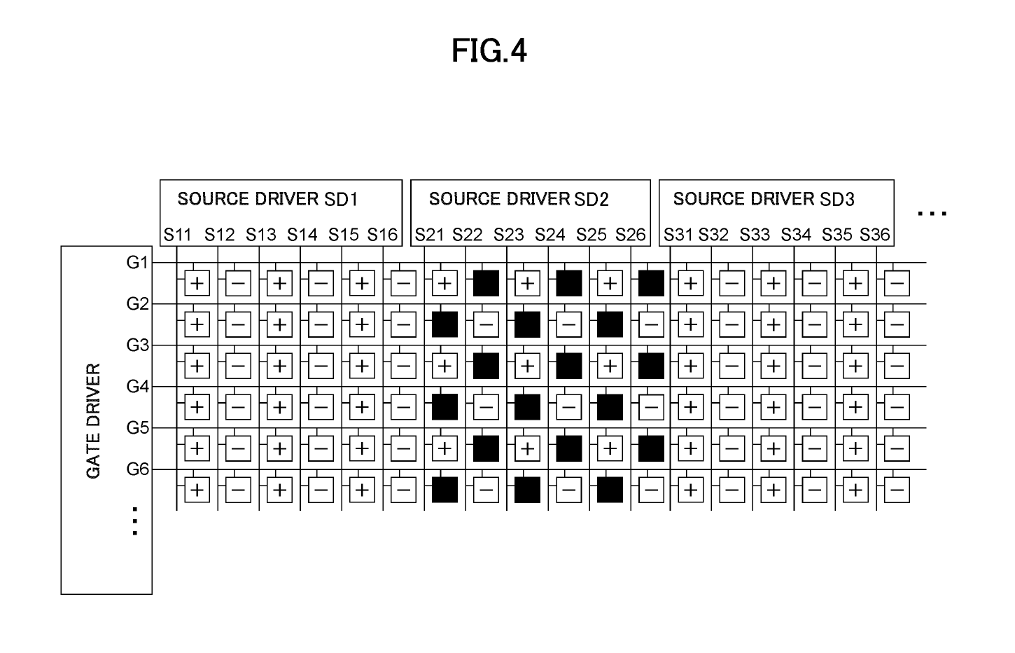

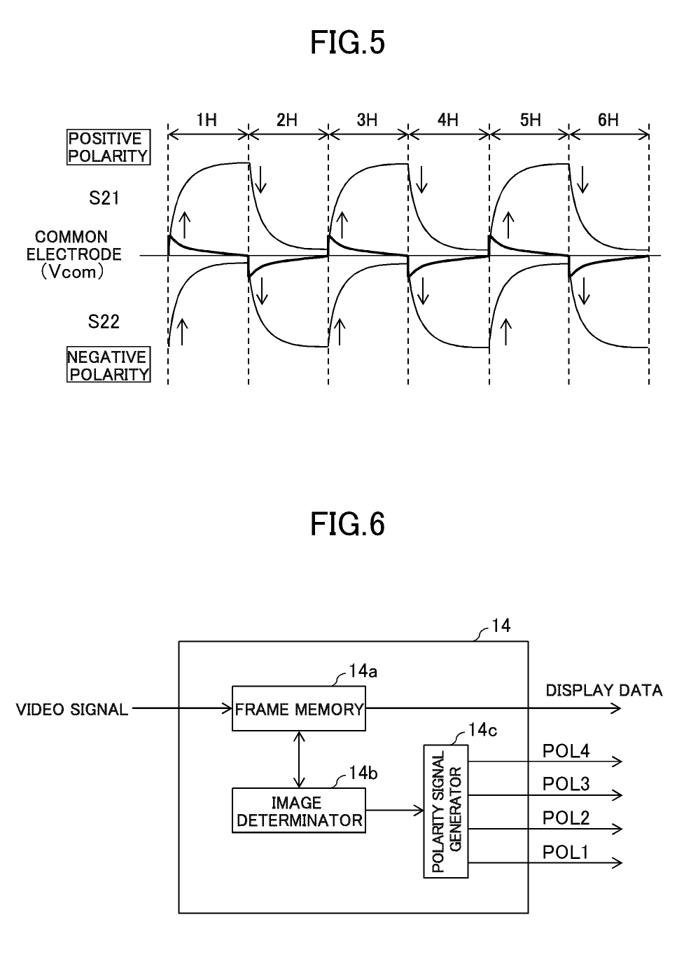

In the liquid crystal display device that performs the column inversion drive, for example, when the frame image in FIG. 2 is displayed, a phenomenon such as black floating appears in the display image to deteriorate the display quality. FIG. 4 is a schematic diagram illustrating a display state of the pixel. FIG. 5 illustrates waveforms of the data signals output to source lines S21, S22 in source driver SD2.

As illustrated in FIGS. 4 and 5, in the display region of the pattern image, the polarity of the pixel in which a white color is displayed and the polarity of the pixel in which a black color is displayed are alternately changed in each row. For example, in the first, third, fifth rows corresponding to gate lines G1, G3, G5, the white color is displayed in the pixel having the positive polarity, and the black color is displayed in the pixel having the negative polarity. On the other hand, in the second, fourth, sixth rows corresponding to gate lines G2, G4, G5, the black color is displayed in the pixel having the positive polarity, and the white color is displayed in the pixel having the negative polarity.

Because voltage level changes of the data signals output to the adjacent source lines SL have similar characteristics, the common voltage (Vcom) varies in association with the data signal change to generate a ripple. For example, as illustrated in FIG. 5, during a transition from a first horizontal scanning period (first H) to a second horizontal scanning period (second H), both the voltage levels of the data signals of source lines S21 and S22 change from the positive polarity side to the negative polarity side (downward in FIG. 5). During a transition from the second horizontal scanning period (second H) to a third horizontal scanning period (third H), both the voltage levels of the data signals of source lines S21 and S22 change from the negative polarity side to the positive polarity side (upward in FIG. 5). Therefore, the ripple is generated on the positive polarity side in the common voltage (Vcom) at beginnings of the first, third, fifth horizontal scanning periods (first H, third H, fifth H), and the ripple is generated on the negative polarity side in the common voltage (Vcom) at beginnings of the second, fourth, sixth horizontal scanning periods (second H, fourth H, sixth H). Because the common voltage is not maintained at Vcom but varies, the display quality is deteriorated.

A specific configuration suppressing common voltage variation will be described below.

FIG. 6 is a block diagram illustrating a schematic configuration of TCON 14. TCON 14 includes frame memory 14a, image determinator 14b, and polarity signal generator 14c. The video signal and various timing signals (the clock signal, the vertical synchronizing signal, and the horizontal synchronizing signal) (not illustrated) are externally input to TCON 14.

The video signal is temporarily stored in frame memory 14a when input to TCON 14 from an external signal source. The video signal (frame image) for one frame is stored in frame memory 14a. As used herein, each frame includes a plurality of horizontal scanning periods (first H, second H, etc.).

Image determinator 14b determines whether the pattern image is included in the video signal input to TCON 14. Specifically, image determinator 14b determines whether the pattern image is included in the frame image by analyzing the frame image stored in frame memory 14a. For example, image determinator 14b determines whether the pattern image is included in the frame image on the basis of whether the pixel group, which has the brightness difference (gradation difference) between pixels adjacent to each other being greater than or equal to a predetermined value, is continued over an area greater than or equal to a predetermined area. When the pattern image is included in the frame image, image determinator 14b determines which one of the driving regions includes the pattern image.

When the determination processing of image determinator 14b is ended, TCON 14 outputs the frame image stored in frame memory 14a to each source driver SD as the display data, and image determinator 14b outputs a result of the determination processing to polarity signal generator 14c. Although not illustrated, TCON 14 outputs the timing signal to each source driver SD together with the display data. Each source driver SD generates the data signal (gradation voltage) on the basis of the display data and timing signal.

Polarity signal generator 14c generates the plurality of polarity signals POL on the basis of the determination result of the image determinator 14b. Polarity signal generator 14c individually outputs each of the plurality of generated polarity signals POL to corresponding source driver SD. For example, when generating polarity signals POL1, POL2, POL3, POL4 on the basis of the determination result, signal generator 14c outputs polarity signals POL1, POL2, POL3, POL4 to source drivers SD1, SD2, SD3, SD4, respectively.

Each source driver SD decides (adds) the polarity of the data signal on the basis of input polarity signal POL input from polarity signal generator 14c.

Frame memory 14a may be a line memory. In this case, image determinator 14b may analyze the image of one of a plurality of rows to determine whether the pattern image is included.

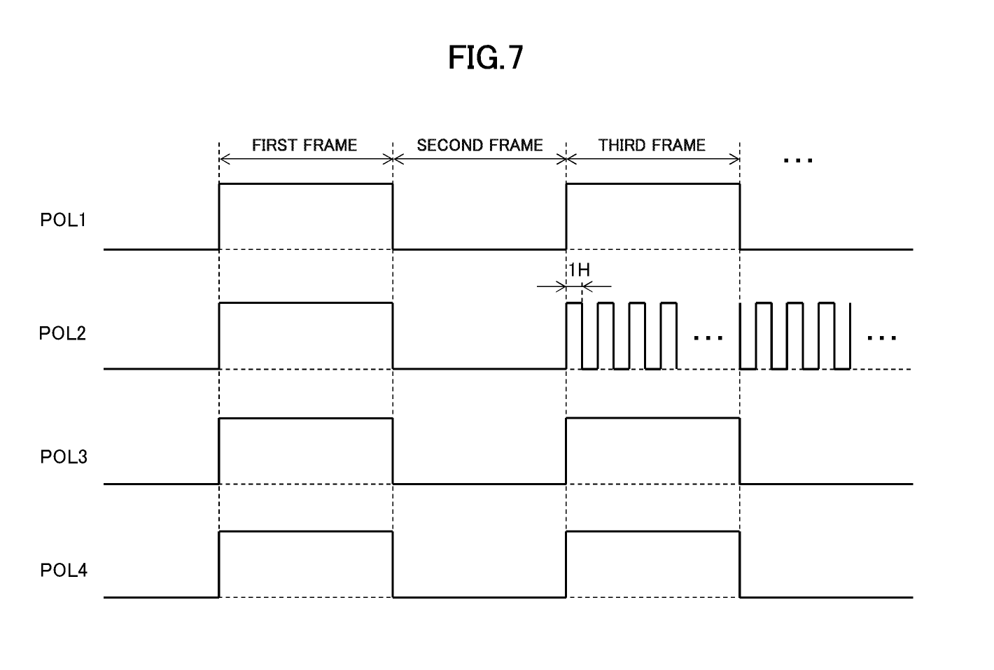

Specific examples of polarity signal POL generated by polarity signal generator 14c and a display operation according to polarity signal POL will be described below. At this point, by way of example, the image in FIG. 2 is displayed from the third frame and later in liquid crystal display device 10 that performs the column inversion drive. FIG. 7 is a timing chart illustrating the waveforms of polarity signals POL.

In the case that the frame image does not include the pattern image in the first and second frames, polarity signal generator 14c generates in-phase polarity signals POL1, POL2, POL3, POL4 pursuant to the column inversion drive (see FIG. 7), and outputs polarity signals POL1, POL2, POL3, POL4 to source drivers SD1, SD2, SD3, SD4, respectively. Source drivers SD1, SD2, SD3, SD4 decide the polarity of the data signal on the basis of polarity signals POL1, POL2, POL3, POL4, and perform the image display according to the column inversion drive. In this case, the polarity of the pixel is similar to that in FIG. 3.

Then, in the third frame, when the video signal corresponding to the frame image in FIG. 2 is input to TCON 14, the frame image is temporarily stored in frame memory 14a. Because the driving region of source driver SD2 includes the pattern image in the frame image, image determinator 14b outputs a signal (determination result) indicating that the driving region includes the pattern image, to polarity signal generator 14c.

When acquiring the determination result, polarity signal generator 14c generates each polarity signal POL on the basis of the determination result. Specifically, as illustrated in FIG. 7, polarity signal generator 14c generates polarity signals POL1, POL3, POL4, which are pursuant to the column inversion drive and correspond to source drivers SD1, SD3, SD4 that drive the region where the pattern image is not included, and polarity signal POL2, which is pursuant to dot inversion drive and corresponds to source driver SD2 that drives the region where the pattern image is included. In the dot inversion drive (1H dot inversion (1-by-1 dot) drive), the data signals supplied to the adjacent source lines SL differs from each other in the voltage polarity while the common voltage (Vcom) is fixed, and the voltage polarity is inverted in each horizontal scanning period (1H).

Polarity signal generator 14c outputs polarity signals POL1, POL3, POL4 pursuant to the column inversion drive to source drivers SD1, SD3, SD4, and outputs polarity signal POL2 corresponding to the dot inversion drive to source driver SD2. Source drivers SD1, SD3, SD4 decide the polarity of the display data on the basis of polarity signals POL1, POL3, POL4, and perform the image display in pursuant to the column inversion drive, and source driver SD2 decides the polarity of the display data on the basis of polarity signal POL2, and performs the image display in pursuant to the dot inversion drive.

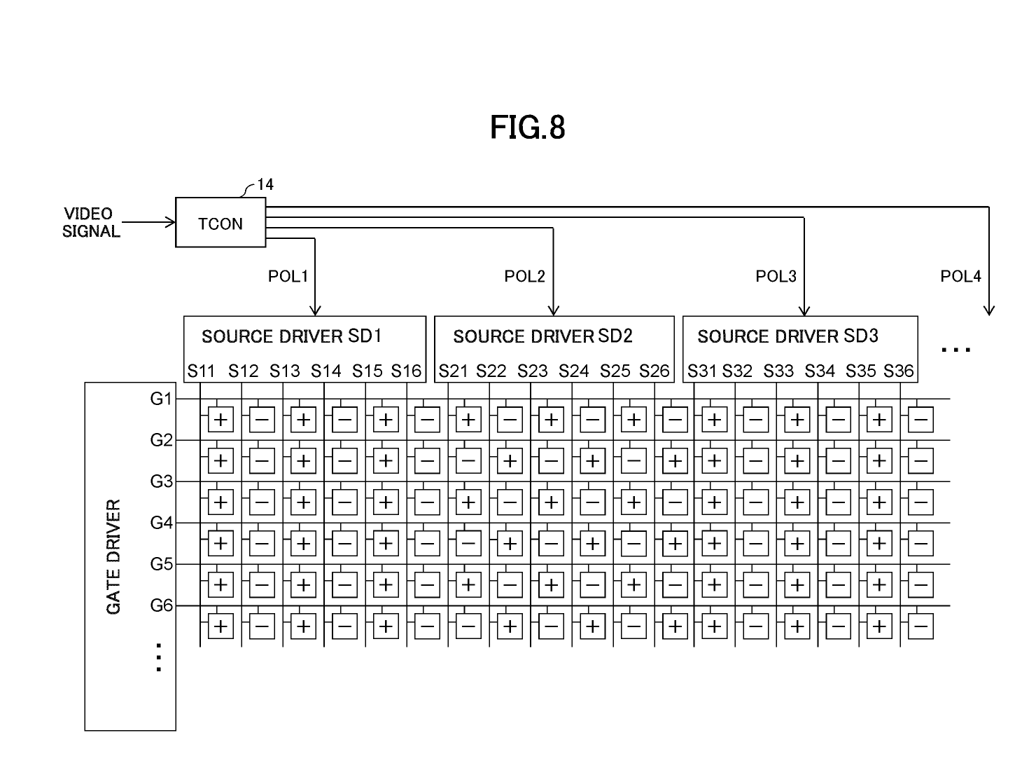

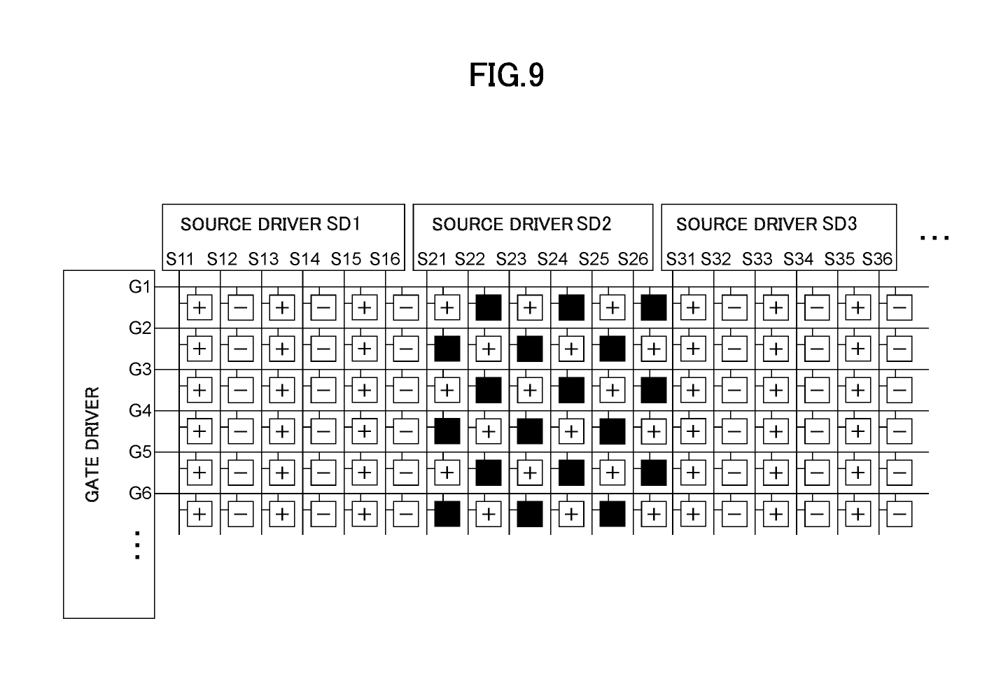

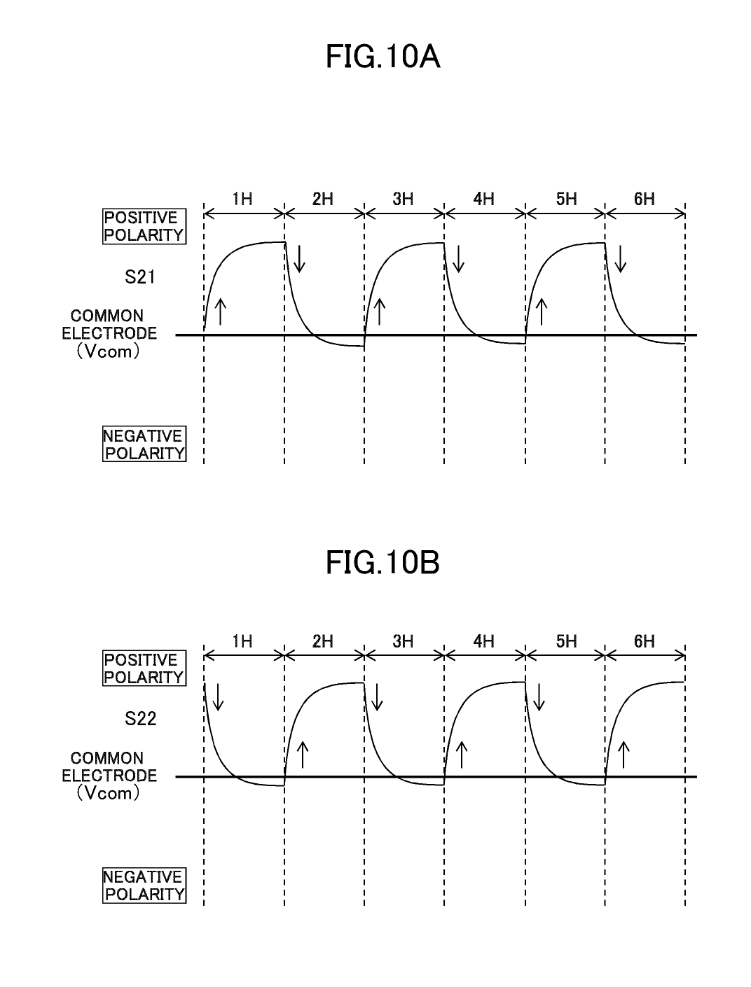

FIG. 8 is a view illustrating a method for driving liquid crystal display device 10 of the exemplary embodiment. FIG. 9 is a schematic diagram illustrating the display state of the pixel of the embodiment. FIG. 10 illustrates waveforms of the data signals output to source lines S21, S22 in source driver SD2 of the exemplary embodiment. For example, FIGS. 8 to 10 illustrate the display operation corresponding to the third frame.

As illustrated in FIG. 8, the driving regions of source drivers SD1, SD3, SD4 (not illustrated) indicate the display operation pursuant to the column inversion drive, and the driving region of source driver SD2 indicates the display operation pursuant to the dot inversion drive.

As illustrated in FIG. 9, for example, in the first to sixth rows corresponding to gate lines G1 to G6, the white color is displayed in the pixel having the positive polarity, and the black color is displayed in the pixel having the negative polarity. In the exemplary embodiment, because voltage level changes of the data signals output to the adjacent source lines SL tend to be different from each other, the common voltage (Vcom) does not vary in association with the data signal change, and the ripple is not generated. For example, as illustrated in FIG. 10, during the transition from the first horizontal scanning period (first H) to the second horizontal scanning period (second H), the voltage level of the data signal of source lines S21 changes from the positive polarity side to the negative polarity side (downward in FIG. 10A), and the voltage level of the data signal of source line S22 changes from the negative polarity side to the positive polarity side (upward in FIG. 10B). Because an influence of the potential change of the data signal is canceled out in each row, the ripple is not generated in the common voltage. Therefore, because the common voltage can be maintained at Vcom, the display quality deterioration can be suppressed. In the exemplary embodiment, the display quality deterioration can be suppressed by the simple configuration in which polarity signal POL is generated in each source driver SD.

### First Modification

In the exemplary embodiment, polarity signal generator 14c generates polarity signal POL such that, in displaying the frame image including the pattern image, the driving method switches from the column inversion drive to the dot inversion drive. However, the present disclosure is not limited to the exemplary embodiment. For example, polarity signal generator 14c may have a configuration in which the phase of corresponding polarity signal POL is changed in displaying the frame image including the pattern image.

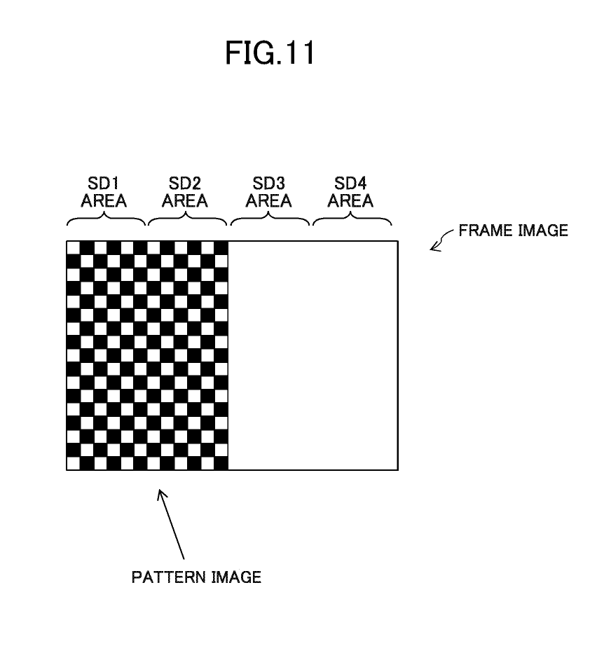

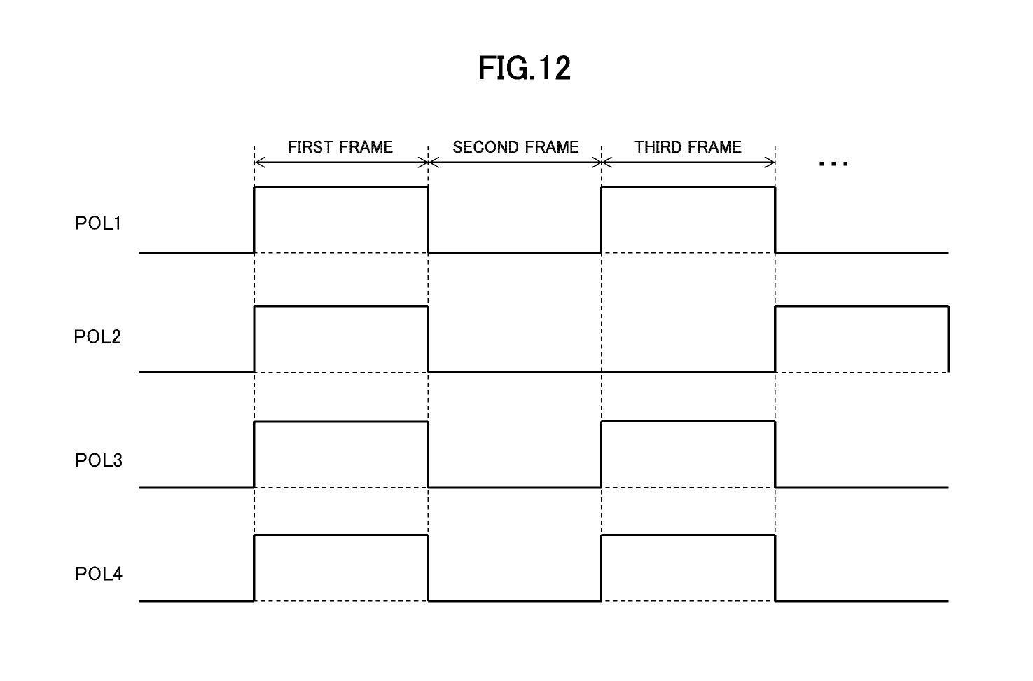

For example, as illustrated in FIG. 11, in the case that pattern image having the black-and-white checkered pattern is included in the frame image over the driving regions of source drivers SD1, SD2, the phase of polarity signal POL1 or POL2 may differ from the phase of another polarity signal POL. FIG. 12 is a timing chart illustrating waveforms in the case that the phase of polarity signal POL2 differs from the phases of polarity signals POL1, POL3, POL4 in the third frame including the pattern image.

Polarity signal generator 14c outputs polarity signals POL1, POL3, POL4 pursuant to the column inversion drive to source drivers SD1, SD3, SD4, and outputs polarity signal POL2 having the phase different from the phases of polarity signals POL1, POL3, POL4, to source driver SD2. Source drivers SD1, SD3, SD4 decide the polarity of the data signal on the basis of polarity signals POL1, POL3, POL4, and perform the image display in pursuant to the column inversion drive, and source driver SD2 decides the polarity of the data signal on the basis of polarity signal POL2, and performs the image display in pursuant to the column inversion drive.

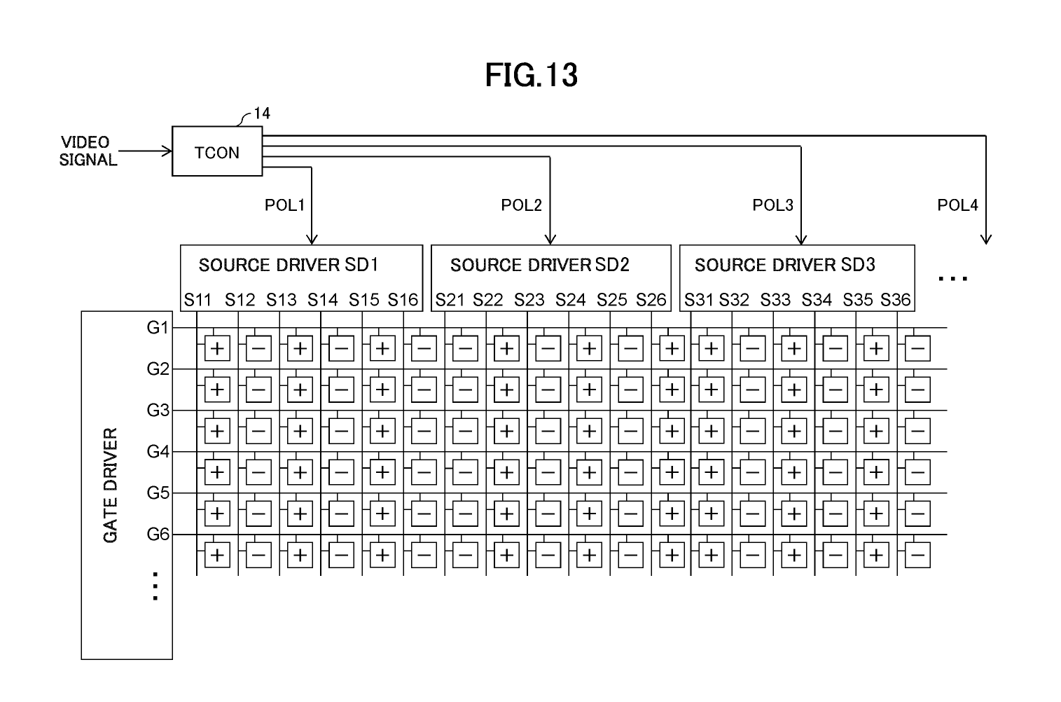

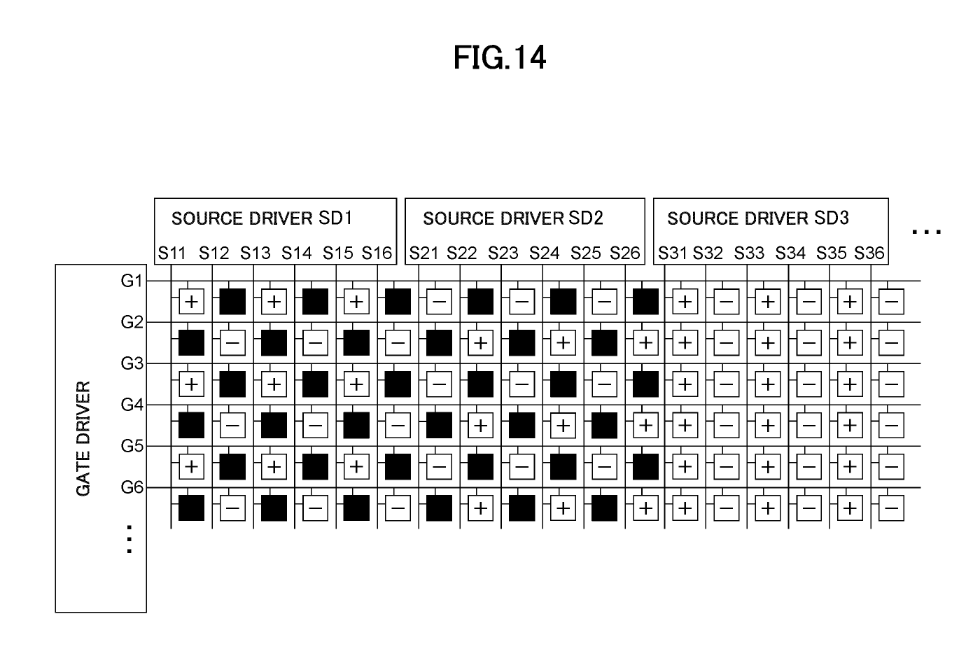

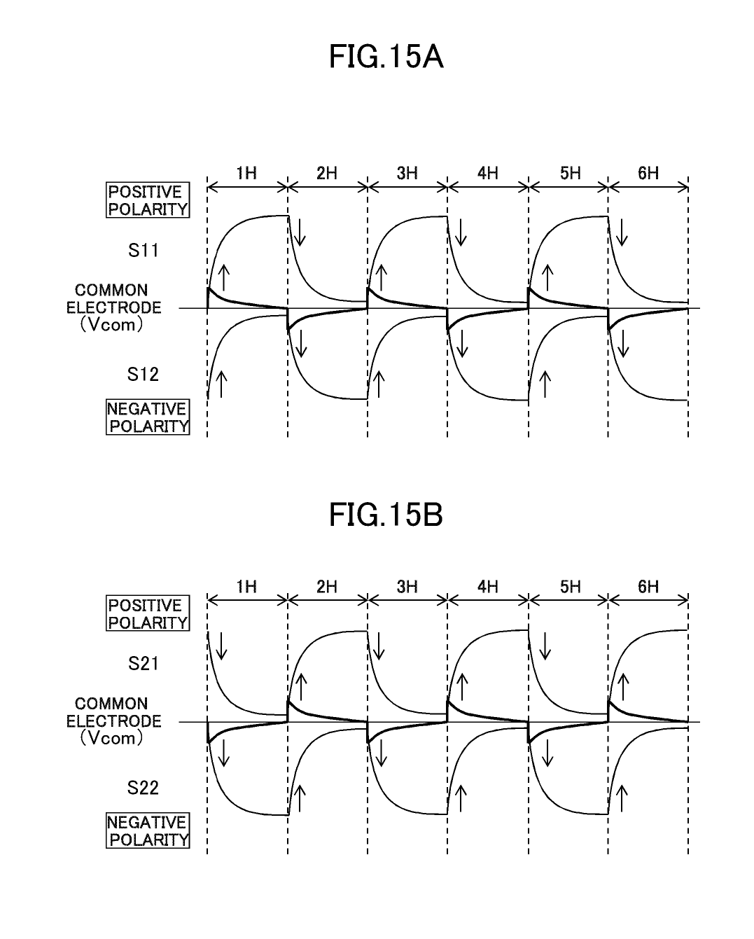

FIG. 13 is a view illustrating a method for driving liquid crystal display device 10 according to a first modification. FIG. 14 is a schematic diagram illustrating the display state of the pixel of the first modification. FIG. 15A illustrates waveforms of the data signals output to source lines S11, S12 in source driver SD1 of the first modification, and FIG. 15B illustrates waveforms of the data signals output to source lines S21, S22 in source driver SD2. For example, FIGS. 13 to 15 illustrate the display operation corresponding to the third frame.

As illustrated in FIG. 13, the driving regions of source drivers SD1 to SD4 perform the display operation pursuant to the column inversion drive, but the driving region of source driver SD2 is different from the driving regions of source drivers SD1, SD3, SD4 in the polarity of the pixel.

As illustrated in FIG. 14, for example, in the driving region of source driver SD1, in the first, third, fifth rows, the white color is displayed in the pixel having the positive polarity, and the black color is displayed in the pixel having the negative polarity. On the other hand, in the second, fourth, sixth rows, the black color is displayed in the pixel having the positive polarity, and the white color is displayed in the pixel having the negative polarity. In the driving region of source driver SD2, in the first, third, fifth rows, the black color is displayed in the pixel having the positive polarity, and the white color is displayed in the pixel having the negative polarity. On the other hand, in the second, fourth, sixth rows, the white color is displayed in the pixel having the positive polarity, and the black color is displayed in the pixel having the negative polarity.

In the first modification, the data signal output to source line SL in source driver SD1 differs from the data signal output to source line SL in source driver SD2 in the voltage level changing direction; therefore, the influence of the potential change of the data signal is canceled out in each row, and the common voltage (Vcom) is averaged as a whole. For example, as illustrated in FIG. 15, during the transition from the first horizontal scanning period (first H) to the second horizontal scanning period (second H), the voltage levels of the data signals of source lines S11, S12 of source driver SD1 change from the positive polarity side to the negative polarity side (downward in FIG. 15A), and the voltage levels of the data signals of source lines S21, S22 change from the negative polarity side to the positive polarity side (upward in FIG. 15B).

Because the common electrode is planarly disposed over the whole surface of the display region, the influence of the potential change of the data signal is canceled out and averaged as a whole in the common voltage (Vcom). Therefore, because the common voltage can be maintained at Vcom, the display quality deterioration can be suppressed. In liquid crystal display device 10 of the first modification, the whole driving region can be displayed in pursuant to the column inversion drive, so that power saving can be achieved.

As described above, polarity signal generator 14c individually generates polarity signal POL in each source driver SD according to a content of the input image. Each source driver SD performs polarity inversion drive according to polarity signal POL individually generated with polarity signal generator 14c.

### Second Modification

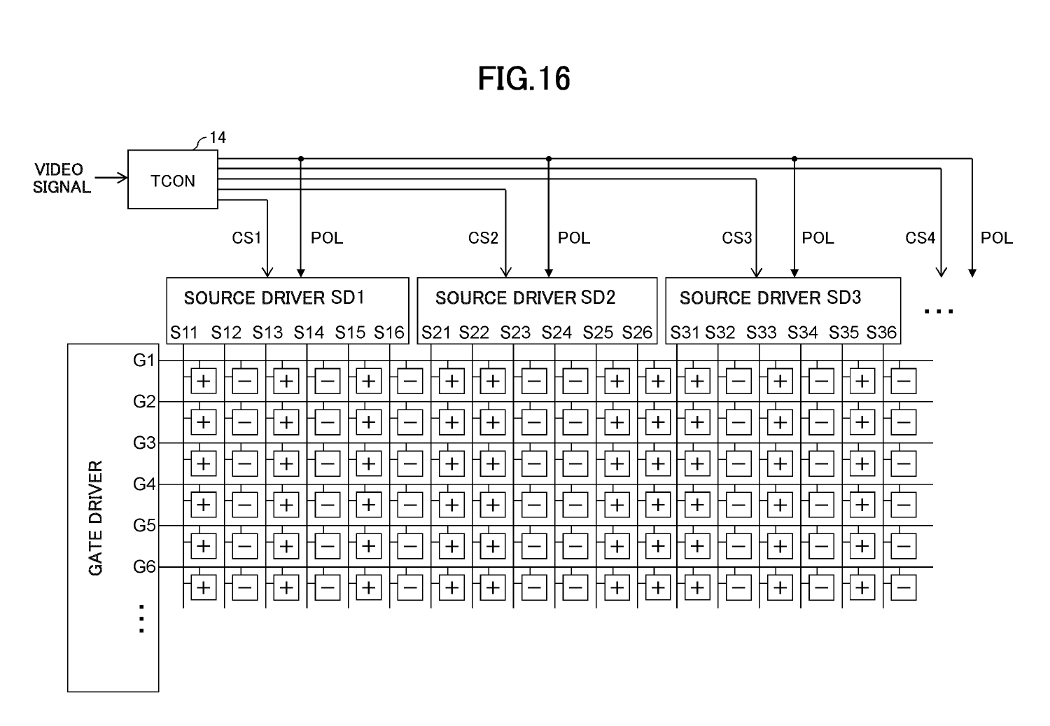

FIG. 16 is a view illustrating a schematic configuration of liquid crystal display device 10 according to a second modification. In liquid crystal display device 10 of the second modification, liquid crystal panel 11 includes a function of performing the display by switching one-column inversion drive and two-column inversion drive. Although not illustrated, a first terminal for the one-column inversion drive, a second terminal for the two-column inversion drive, and a selector switch that switches between the first and second terminals are provided in each source driver SD. The operation to switch between the one-column inversion drive and the two-column inversion drive is performed by applying control signal CS output from TCON 14 to the selector switch. For example, the one-column inversion drive is selected when low-level (L) control signal CS is input to source driver SD, and the two-column inversion drive is selected when high-level (H) control signal CS is input to source driver SD. Thus, in liquid crystal display device 10 of the second modification, each source driver SD performs the image display in pursuant to the one-column inversion drive or the two-column inversion drive on the basis of control signal CS individually input from TCON 14.

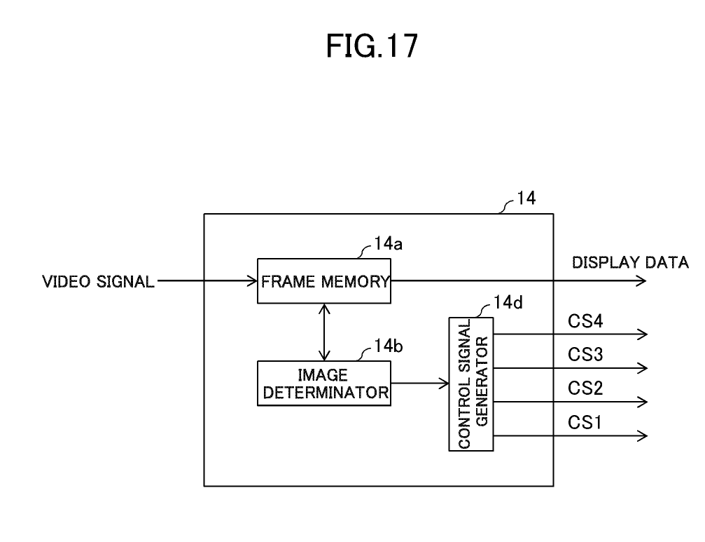

FIG. 17 is a block diagram illustrating a schematic configuration of TCON 14 of the second modification. TCON 14 includes frame memory 14a, image determinator 14b, and control signal generator 14d.

Control signal generator 14d generates a plurality of control signals CS on the basis of the determination result of image determinator 14b. Control signal generator 14d individually outputs each of the plurality of generated control signals CS to corresponding source driver SD. For example, when the voltage levels (H and L) of control signals CS1, CS2, CS3, CS4 are decided on the basis of the determination result, control signal generator 14d outputs control signals CS1, CS2, CS3, CS4 to source drivers SD1, SD2, SD3, SD4, respectively. Each source driver SD perform the image display in pursuant to the one-column inversion drive or two-column inversion drive, which is selected on the basis of each control signal CS input from control signal generator 14d.

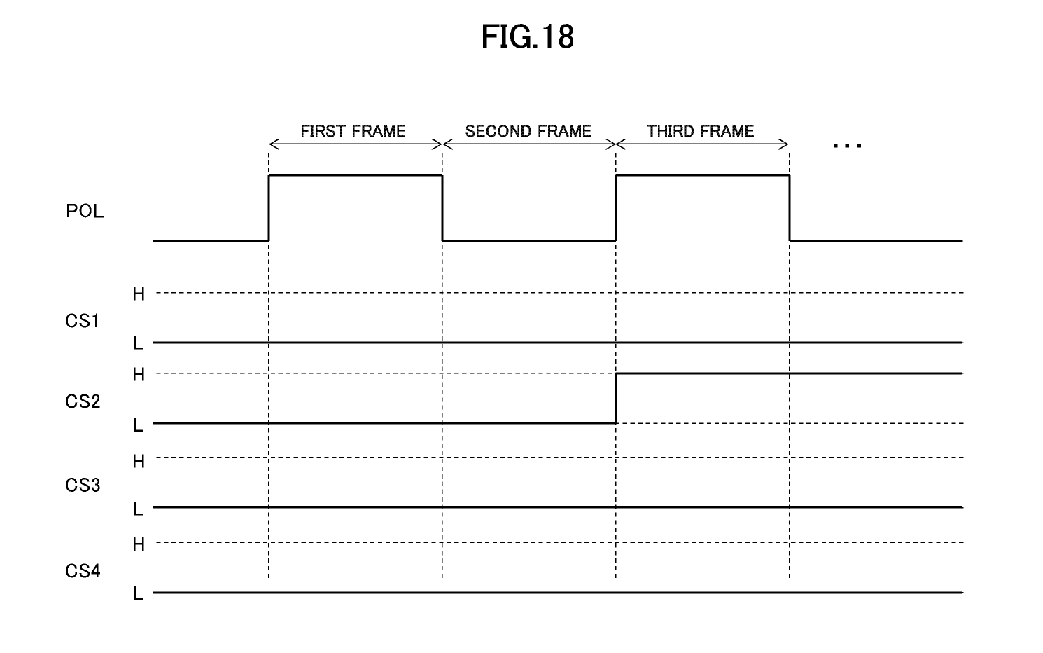

Specific examples of control signal CS generated by control signal generator 14d and a display operation according to control signal CS will be described below. At this point, by way of example, the image in FIG. 2 is displayed from the third frame and later in liquid crystal display device 10 that performs the column inversion drive. FIG. 18 is a timing chart illustrating the waveforms of polarity signals POL and a control signals CS.

In the case that the frame image does not include the pattern image in the first and second frames, control signal generator 14d outputs low-level (L) control signals CS1, CS2, CS3, CS4 to source drivers SD1, SD2, SD3, SD4, respectively (see FIG. 18). When control signals CS1, CS2, CS3, CS4 are input, source drivers SD1, SD2, SD3, SD4 perform the image display in pursuant to the one-column inversion drive. In this case, the polarity of the pixel is similar to that in FIG. 3.

Then, in the third frame, because the driving region of source driver SD2 includes the pattern image (see FIG. 2), control signal generator 14d outputs high-level (H) control signal CS2 to source driver SD2, and outputs low-level (L) control signals CS1, CS3, CS4 to source drivers SD1, SD3, SD4 (see FIG. 18). Source driver SD2 performs the display image in pursuant to the two-column inversion drive when control signal CS2 is input (see FIG. 16), and source drivers SD1, SD3, SD4 perform the display image in pursuant to the one-column inversion drive when control signals CS1, CS3, CS4 are input (see FIG. 16).

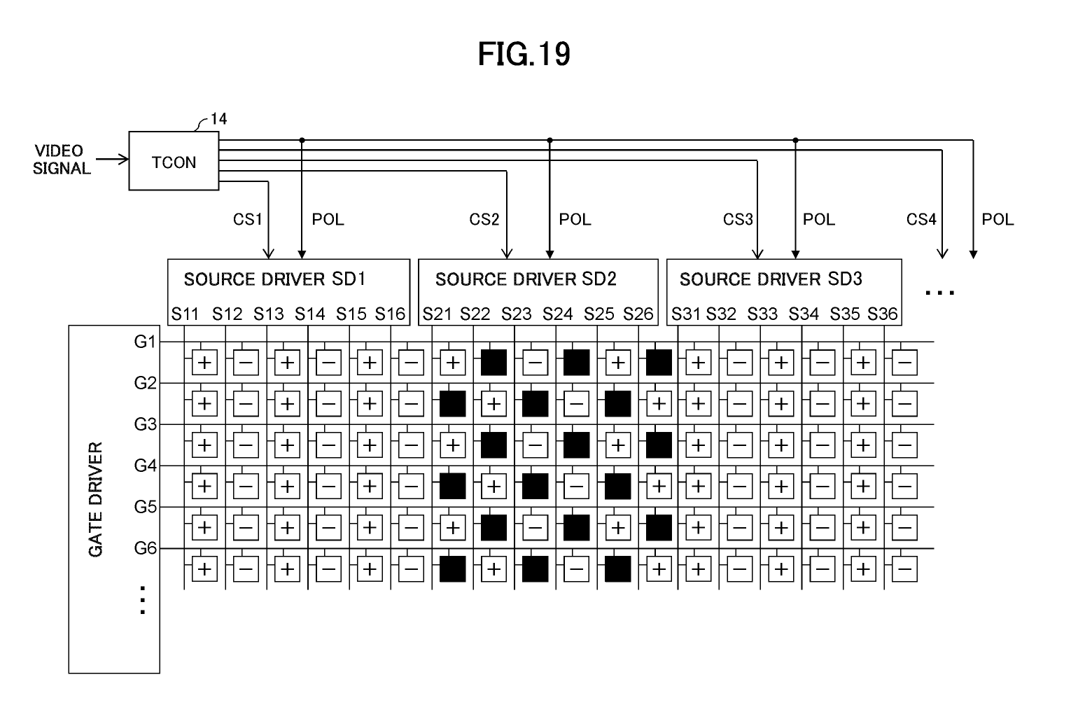

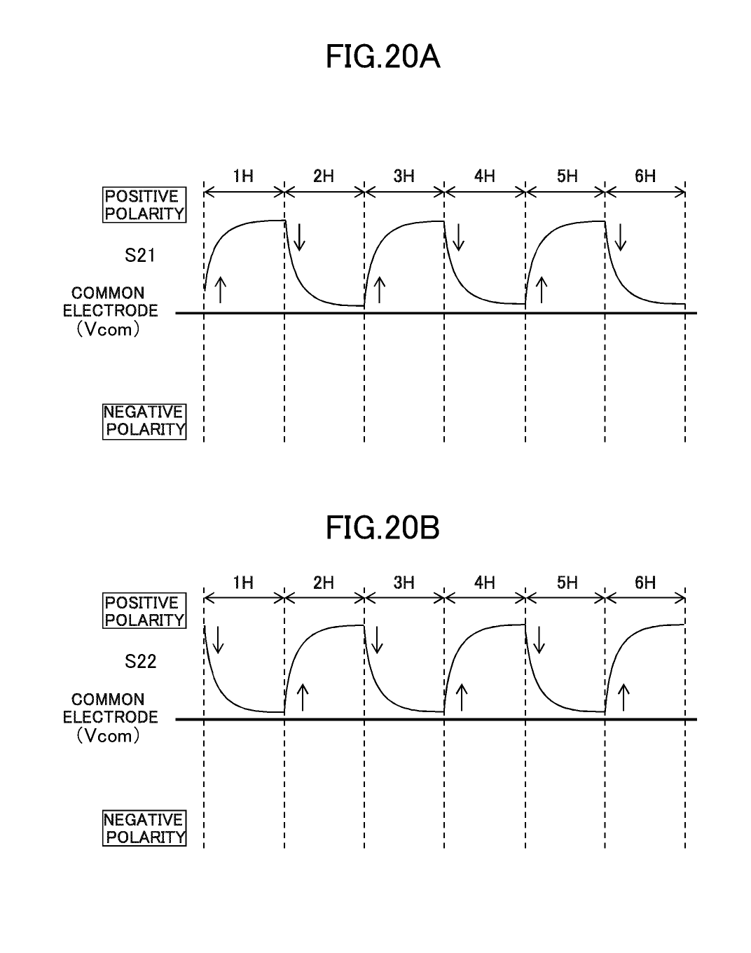

FIG. 19 is a schematic diagram illustrating the display state of the pixel of the second modification. FIG. 20 illustrates the waveforms of the data signals output to source lines S21, S22 in source driver SD2 of the second modification. For example, FIGS. 19 and 20 illustrate the display operation corresponding to the third frame.

As illustrated in FIG. 19, in the driving region of source driver SD2, because the data signals output to the adjacent source lines SL are different from each other in the voltage level changing direction, the common voltage (Vcom) does not vary in association with the data signal change, and the ripple is not generated. For example, as illustrated in FIG. 20, during the transition from the first horizontal scanning period (first H) to the second horizontal scanning period (second H), the voltage level of the data signal (positive polarity) of source lines S21 changes from the positive polarity side to the negative polarity side (downward in FIG. 20), and the voltage level of the data signal (positive polarity) of source line S22 changes from the negative polarity side to the positive polarity side (upward in FIG. 20). Similarly, for the positive-polarity source lines S23, S24 adjacent to each other, the data signals differ from each other in the voltage level changing direction. Because an influence of the potential change of the data signal is canceled out in each row, the ripple is not generated in the common voltage. Therefore, because the common voltage can be maintained at Vcom, the display quality deterioration can be suppressed.

In the above, the specific embodiments of the present application have been described, but the present application is not limited to the above-mentioned embodiments, and various modifications may be made as appropriate without departing from the spirit of the present application.

What is claimed is:

1. A liquid crystal display device comprising: a plurality of data lines;
a plurality of scanning lines;
a plurality of source drivers that supply a data signal to the plurality of data lines;
a gate driver that supplies a scanning signal to the plurality of scanning lines; and
a display control circuit that controls the plurality of source drivers and the gate driver,
wherein the display control circuit includes an image determinator that determines whether an externally-input image includes a pattern image and a polarity signal generator that generates a polarity signal deciding a voltage polarity of the data signal in each source driver based on a determination result of the data signal, and
the polarity signal generator individually outputs each of the plurality of generated polarity signals to the corresponding source driver.

2. The liquid crystal display device according to claim 1, wherein the pattern image is an image in a region where a pixel group having a brightness difference between adjacent pixels that is greater than or equal to a predetermined value is continued over an area greater than or equal to a predetermined area.

3. The liquid crystal display device according to claim 1, wherein each of the source drivers is connected to a respective driving region and the image determinator determines which one of the driving regions includes the pattern image, and
based on the determination result of the image determinator, the polarity signal generator outputs a first polarity signal to the source driver that drives the driving region including the pattern image, and outputs a second polarity signal to the source driver that drives the driving region that does not include a pattern image.

4. The liquid crystal display device according to claim 3, wherein the pattern image is a checkered pattern image in which black and white are alternately changed in each pixel,
the first polarity signal is a signal in which a high level and a low level are switched in each frame, and
the second polarity signal is a signal in which a high level and a low level are switched in each horizontal scanning period in a period during which the pattern image is displayed, and is an in-phase signal of the first polarity signal in a period during which the pattern image is not displayed.

5. The liquid crystal display device according to claim 4, wherein the source driver to which the first polarity signal is input performs column inversion drive, and
the source driver to which the second polarity signal is input performs the column inversion drive in the period during which the pattern image is not displayed, and performs dot inversion drive in the period during which the pattern image is displayed.

6. The liquid crystal display device according to claim 3, wherein the pattern image is a checkered pattern image in which black and white are alternately changed in each pixel,
the first polarity signal is a signal in which a high level and a low level are switched in each frame, and
the second polarity signal is an anti-phase signal of the first polarity signal in a period during which the pattern image is displayed, and is a signal having an in-phase signal of the first polarity signal in a period during which the pattern image is not displayed.

7. The liquid crystal display device according to claim 6, wherein each of the plurality of source drivers performs the column inversion drive, and
the pixel in the driving region of the source driver to which the second polarity signal is input and the pixel in the driving region of the source driver to which the first polarity signal is input differ from each other in the voltage polarity.

8. A liquid crystal display device comprising: a plurality of data lines;
a plurality of scanning lines;
a plurality of source drivers that supply a data signal to the plurality of data lines, each of the plurality of source drivers includes a switch that switches between a one-column inversion drive and a two-column inversion drive;
a gate driver that supplies a scanning signal to the plurality of scanning lines; and
a display control circuit that controls the plurality of source drivers and the gate driver,
wherein the display control circuit includes:
an image determinator that determines whether an externally-input image includes a pattern image, and
a control signal generator that generates a control signal switching between the one-column inversion drive and the two-column inversion drive in each source driver based on a determination result of the image determinator, and
the control signal generator outputs each of the plurality of generated control signals to the switch of the corresponding source driver.
